(19) United States
(12) Patent Application Publication
(10) Pub. No.: US 2026/0278903 A1
(43) Pub. Date: Sep. 17, 2026

(54) GENERATIVE ANIMATIONS ENGINE IN AN ARTIFICIAL INTELLIGENCE SYSTEM

(71) Applicant: Microsoft Technology Licensing, LLC, Redmond, WA (US)

(72) Inventors: Zeinab KAZEMI ALAMOUTI, Sunnyvale, CA (US); Fatima Zohra Daha, Livermore, CA (US); Andrew John Moroney, Seattle, WA (US)

(21) Appl. No.: 19/077,378

(22) Filed: Mar. 12, 2025

(51) Int. Cl. G06T 13/80; G06T 11/60

(52) U.S. Cl. CPC G06T 13/80; G06T 11/60

(57) ABSTRACT

Methods, systems, and computer storage media for providing generative animation management using a generative animation engine in an artificial intelligence (AI) system are described. The generative animation engine supports algorithmically generating animated design objects utilizing large language models (LLMs). It operates based on a dual-component input prompt comprising a user prompt and a meta-prompt. The meta-prompt specifies a parameterized schema for the animation object, including constraints on behavioral dynamics, temporal properties, interpolation techniques, and other attributes. Operationally, an input associated with generating a generative animation is accessed. The input comprises contextual data for generating the generative animation. A meta-prompt is generated based on input and a predefined meta-prompt template. The predefined meta-prompt template defines animation parameters as operational constraints for animation generation. Based on the meta-prompt, an animation object is generated. The animation object comprises computed animation parameters. The animation object is communicated to cause generation of the generative animation.

### BACKGROUND

Users rely on design platforms to create, edit, and enhance visual content, ranging from graphic design and presentations to motion graphics and animations. These design platforms provide a suite of tools that allow designers to manipulate text, images, shapes, and animations to develop visually compelling content for various media, including print, web, and video. Traditional design platforms primarily rely on manual input, where users must specify design elements, animations, and transitions explicitly through user interfaces that involve drag-and-drop functionalities, keyframe-based animation systems, and layer adjustments. For example, a user might manually set keyframes and adjust layer positions in design platforms to create an animation, a process that requires precise timing and expertise. These platforms often require users to have a certain level of expertise to achieve desired results, as the process can be time-consuming and complex. Additionally, the flexibility of design is limited by the tools available, which can hinder efficiency and creativity for users who are not familiar with advanced techniques.

### SUMMARY

Various aspects of the technology described herein are generally directed to systems, methods, and computer storage media for, among other things, providing generative animation management using a generative animation engine in an artificial intelligence (AI) system. Generative animation management is the automated process of creating, organizing, and deploying dynamic animations using AI and computational techniques. The generative animation engine supports algorithmically generating animated design objects utilizing large language models (LLMs). The LLM synthesizes animation data encoded in a structured format (e.g., JSON), which is subsequently integrated into design software platforms (e.g., Microsoft Designer, PowerPoint) to facilitate dynamic visual content creation.

The generative animation engine operates based on a dual-component input prompt comprising a user prompt and a meta-prompt. The meta-prompt specifies a parameterized schema for the animation object, including constraints on behavioral dynamics, temporal properties (such as speed), interpolation techniques, and other relevant attributes. The generative animation engine further incorporates both zero-shot and multi-shot examples to provide exemplar outputs, thereby guiding the LLM in generating the desired animation schema.

Based on the contextual information provided in the user prompt, the LLM produces a customized animation object that aligns with the intended thematic and contextual nuances of the design. This animation object is then programmatically applied to backend design suggestions, enabling seamless incorporation into various design elements, including text, shapes, and other graphical components.

In operation, an input associated with generating a generative animation is accessed. The input comprises contextual data for generating the generative animation. A meta-prompt is generated based on input and a predefined meta-prompt template. The predefined meta-prompt template defines animation parameters as operational constraints for animation generation. Based on the meta-prompt, an animation object is generated. The animation object comprises computed animation parameters. The animation object is communicated to cause generation of the generative animation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A-1D are generative animation schematics associated with a generative animation workflow of a generative animation engine, in accordance with aspects of the technology described herein;

FIG. 2A is a block diagram of an exemplary AI system including a generative animation engine, in accordance with aspects of the technology described herein;

FIG. 2B is a flow diagram associated with an exemplary AI system including a generative animation engine, in accordance with aspects of the technology described herein;

FIG. 3 provides a first exemplary method of providing generative animation management using a generative animation engine, in accordance with aspects of the technology described herein;

FIG. 4 provides a second exemplary method of providing generative animation management using a generative animation engine, in accordance with aspects of the technology described herein;

FIG. 5 provides a third exemplary method of providing generative animation management using a generative animation engine, in accordance with aspects of the technology described herein;

FIG. 6 provides a block diagram of an exemplary computing system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

Design platforms are software applications that enable users to create, edit, and enhance visual content, ranging from graphic design and presentations to motion graphics and animations. These design platforms provide a suite of tools that allow designers to manipulate text, images, shapes, and animations to develop visually compelling content for various media, including print, web, and video. Traditional design platforms, such as Adobe Photoshop, Illustrator, PowerPoint, and Canva, primarily rely on manual input, where users must specify design elements, animations, and transitions explicitly through user interfaces that involve drag-and-drop functionalities, keyframe-based animation systems, and layer adjustments.

Early attempts to incorporate artificial intelligence (AI) into design platforms aimed to automate repetitive design tasks and enhance usability, particularly for non-expert users. One of the earliest applications of AI in design was in image editing and enhancement, where machine learning algorithms were used for automatic background removal, color correction, and object recognition. AI-powered features introduced intelligent recommendations for layout adjustments, font pairing, and content-aware fills, significantly reducing the effort required for complex design edits. Similarly, other design platforms integrated AI-driven design suggestions to help users create visually balanced compositions with minimal manual adjustments.

In the context of animation, early AI-driven approaches focused on automating transitions and motion graphics by applying predefined templates. For example, presentation software introduced AI-assisted features such as “Design Ideas” and “Morph,” which analyze slide content and suggest smooth transitions without requiring manual animation configuration. However, these early implementations still relied heavily on static rules and lacked the ability to dynamically adapt animations based on context, emotional tone, or user intent.

More advanced AI applications have attempted to integrate generative models that enable on-the-fly content creation. For instance, machine learning models have been applied to generate custom design elements, automate typography adjustments, and even create entirely new layouts based on user input. Despite these advancements, most AI-driven animation tools still depend on predefined templates or heuristics rather than true generative intelligence capable of producing dynamic, context-aware animations tailored to user intent. The challenge remains in developing AI systems that can interpret creative goals, synthesize structured animation objects, and seamlessly integrate them into design workflows without requiring extensive manual intervention.

Conventionally design platforms are not configured with a comprehensive computing logic and infrastructure to provide automated creation, organization, and deployment of dynamic animations using AI and computational techniques. Traditional animation tools require extensive manual input, including defining keyframes, setting timing sequences, and configuring transformation properties, making the process time-consuming and inaccessible to non-experts; they also rely on predefined templates that fail to adapt animations based on contextual factors such as emotional tone, event type, or audience, resulting in generic outputs; furthermore, the lack of a structured, machine-readable animation representation forces reliance on prebuilt assets or frame-by-frame adjustments, making it difficult to generate, modify, and integrate animations programmatically across different platforms.

Ultimately, current automation tools may help with basic tasks, but they lack the flexibility, customization, and contextual intelligence that a generative animation system powered by AI offers—making it much harder to create high-quality, personalized animations on demand. As such, a more comprehensive AI system—with an alternative basis for performing generative animation management—can improve computing operations and interfaces for artificial intelligence systems.

### DESCRIPTION OF TECHNICAL SOLUTION

At a high level, the generative animation engine is an AI-driven system for generating and managing dynamic animations within design platforms by utilizing a large language model (LLM) to process user prompts and structured meta-prompts, which define animation behavior, timing, interpolation, and looping parameters. The generative animation engine synthesizes structured animation objects, refines them through a dynamic animation control engine, and seamlessly integrates them into design elements, ensuring context-aware, programmatically generated animations without manual intervention.

Utilizing a design platform such as Microsoft Designer, this generative animation engine enables users to select a design template and specify animation effects through a text-based prompt. The backend system processes the user input by generating multiple concurrent requests to a large language model (LLM), such as GPT-4O, each request containing both the user-provided prompt and a structured meta-prompt. The meta-prompt defines the operational constraints for animation generation, including behavioral properties, timing sequences, motion interpolation, and speed control. Additionally, it provides example animations (zero-shot and multi-shot) to establish reference outputs for the LLM.

Upon receiving these structured inputs, the LLM synthesizes animation objects encoded in a structured format (e.g., JSON) that encapsulate the computed animation parameters. These animation objects are then systematically applied to design suggestions, dynamically modulating the visual elements within the selected template. The resulting animations enhance the overall visual composition by integrating seamlessly with the design framework, ensuring a contextually adaptive and computationally efficient animation generation process.

For example, a fashion retailer launching a new clothing line could use the system to automatically generate tailored animations for their online advertisements. By simply inputting the clothing brand's style, color scheme, and specific product details, the generative animation engine interprets this data and uses its language model capabilities to create dynamic animations that align with the brand's voice and aesthetic. If the retailer wants a more energetic animation for a specific campaign, the generative animation engine will adapt the visuals, ensuring that the animation reflects the desired mood. This removes the need for manual adjustments or expert-level knowledge of animation software, allowing the marketing team to quickly generate high-quality, customized animations at scale.

Operationally, a context-driven approach is employed to determine the appropriate animation style by analyzing the emotional cues and contextual hints embedded in user input. Through this analysis, the LLM can match the content with an animation style suited to factors such as tone, event type, and audience. To facilitate structured animation generation, a multi-phase meta-prompt design is implemented. In the first phase, emotional tone analysis is performed, where key themes in the user's input are identified, allowing animations to be adjusted in energy and style, such as high-energy for excitement or minimalist for calm. The second phase involves guided animation generation, during which animations are produced in adherence to specific rules governing timing, transformations, and interpolation curves. JSON formatting is used to structure the output into two distinct components—pageAnimation and textAnimation—ensuring consistency in structure and output. The final phase focuses on rendering optimization, where the LLM is provided with a standardized meta-prompt, directing it to produce outputs in a structured dictionary format that remains compatible with the rendering engine.

By enabling animations to be generated purely through text-based descriptions, a user-friendly experience is ensured, allowing individuals without animation expertise to create complex animations effortlessly. This is further enhanced through intelligent content analysis and emotion mapping, which allow the generative animation engine to infer the intended emotional tone, target audience, and event context. Emotion detection and theme identification are conducted, mapping key phrases such as “celebration,” “excitement,” and “joy” to high-energy animations, while words like “relax,” “introspection,” and “calm” result in minimalist or soothing styles. Contextual adaptation further refines the output by recognizing contextual hints such as professional events, personal celebrations, or social gatherings, ensuring that animations are not only emotionally aligned but also suited to the intended event or message type.

A meta-prompt is used to guide the LLM in producing contextually adapted, loop-compatible animations in JSON format. To introduce variability, each generated animation is configured with unique parameter combinations, incorporating translation, rotation, and scaling, while alternating between page-only and page-and-text animations. This approach ensures that each output remains distinct. Timing and mood control are adjusted based on energy levels, with predefined timing constraints for high, medium, and calm energy animations. To maintain consistency, the fourth time value—marking the animation's closing frame—is set equal to the maximum time in any property to prevent premature opacity changes. Specific timing ranges are applied, with high-energy animations featuring second time values between 1-2 seconds and looping durations up to 8 seconds, while medium and calm energy animations have progressively longer timing ranges, ensuring smoother transitions.

Opacity and hold frame adjustments are applied to optimize readability, with opacity animations beginning at 0 and increasing to 1 within the first 1.5 seconds, scaled according to the animation's energy level. Hold frames are assigned based on energy level, ensuring that high-energy animations hold for 3.5-5 seconds, medium-energy for 4-6 seconds, and calm-energy for 5-7 seconds. To maintain smooth motion transitions, interpolation curve consistency is enforced, restricting interpolation curves to predefined types such as “EaseOut” for entry points. In looping animations, interpolation curves are systematically placed on the first and third value lines to ensure fluid motion across cycles.

Distribution delays for page animations and text animations are set according to energy levels, with high-energy animations having minimal delays of 0.05-0.2 seconds, while medium and calm energy levels feature slightly longer delays of 0.1-0.3 seconds and 0.2-0.4 seconds, respectively. To ensure seamless looping, keyframe values are aligned, with the second and third value lines remaining identical in a keyframe to preserve smooth motion continuity. The final opacity time is synchronized with the longest duration in any keyframe to prevent premature fading and to ensure all elements transition seamlessly. By following these structured animation generation techniques, the generative animation engine enables a scalable, adaptable, and computationally efficient method for integrating dynamic animations into design platforms.

By way of example, a user creating a promotional graphic for a summer sale in design platform selects a pre-designed template and inputs the following prompt:

“Animate the text to slide in from the left with a bounce effect, and make the background gradually fade in. The animation should loop smoothly and feel energetic.”

Upon receiving the input, the backend system initiates multiple concurrent requests to a large language model (LLM), such as GPT-4O, embedding both the user prompt and a structured meta-prompt. The meta-prompt specifies key animation parameters, such as motion behavior, timing constraints, interpolation techniques, and looping conditions. It also includes example animations demonstrating the expected behavior in both zero-shot and multi-shot formats to refine the LLM's output.

The LLM processes these inputs and generates a structured animation object in JSON format. This object encodes detailed animation properties, specifying that the text will translate from left to right with an “EaseOutBounce” interpolation, while the background will gradually increase in opacity over 1.5 seconds. A looping behavior is added, ensuring that after a short hold, the animation restarts smoothly.

Once the animation object is generated, the system applies it to the selected template. The text dynamically enters the design space with a bouncing effect, and the background smoothly fades in, creating a visually engaging and contextually adaptive animation. The final animation is seamlessly integrated into Microsoft Designer, allowing the user to preview and apply it without requiring manual keyframe adjustments or animation expertise.

### Example Systems and Resources

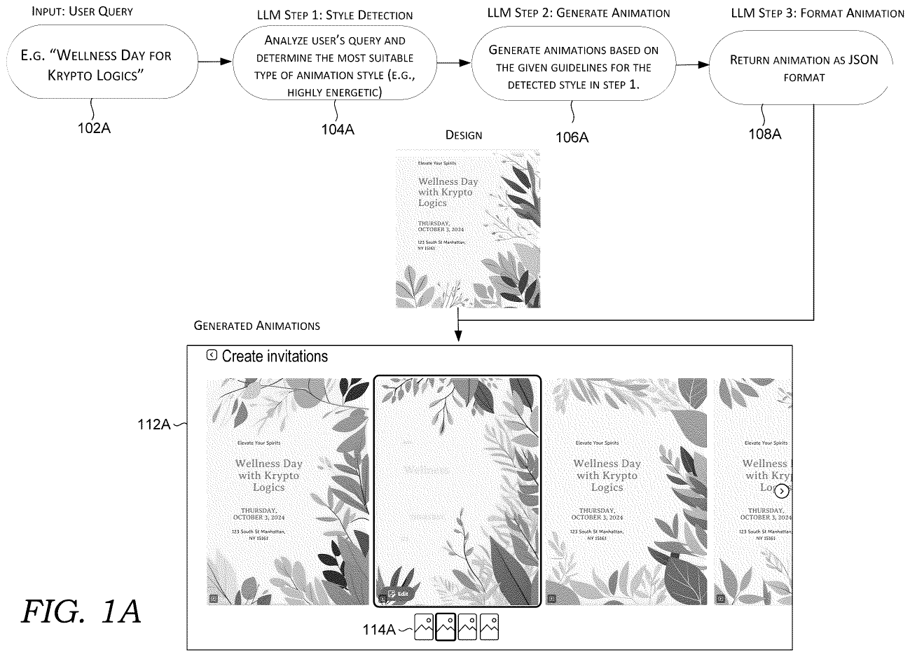

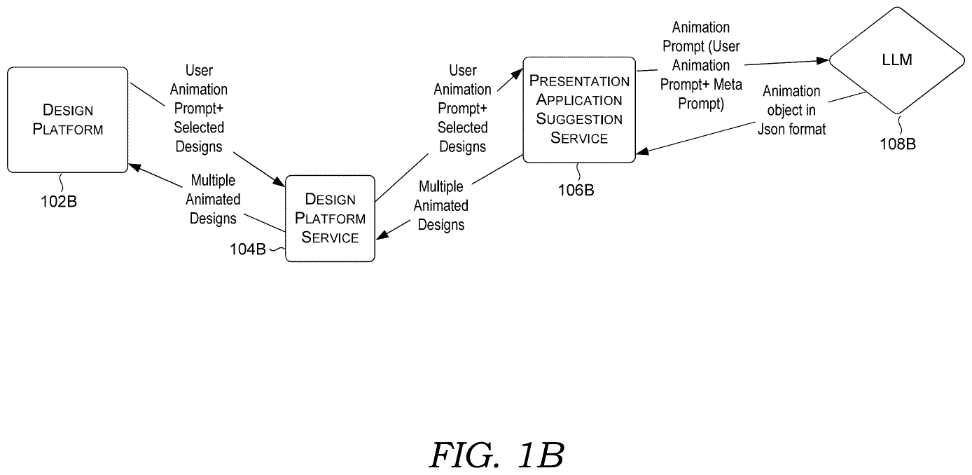

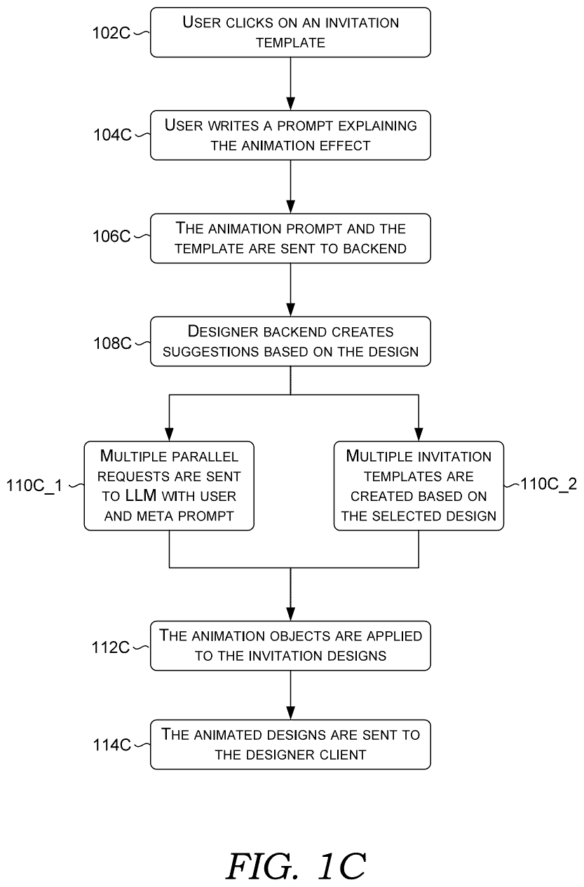

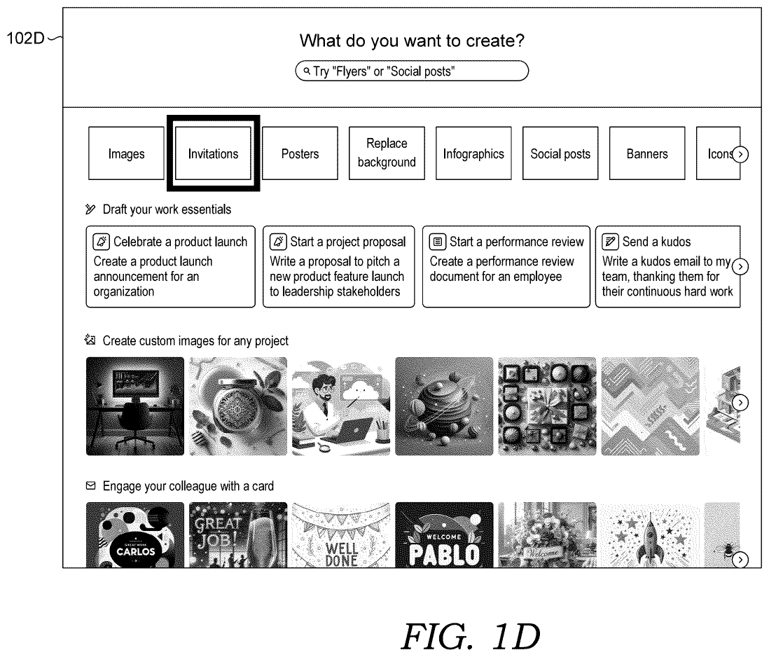

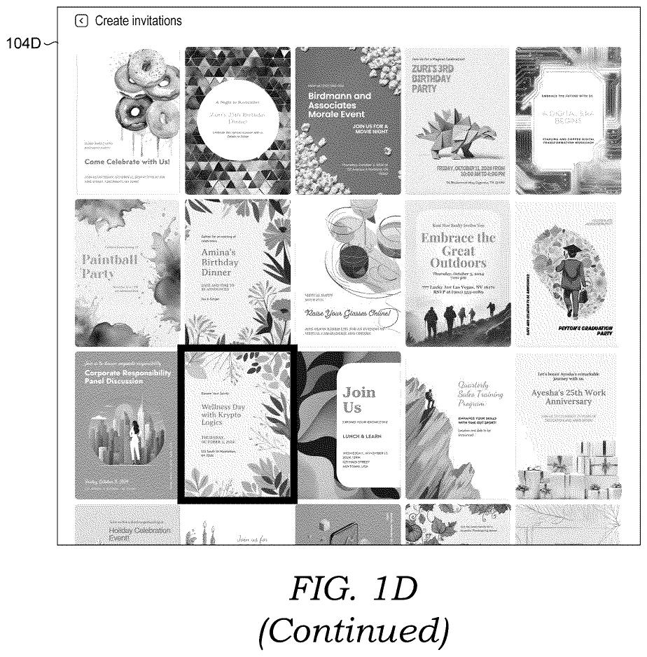

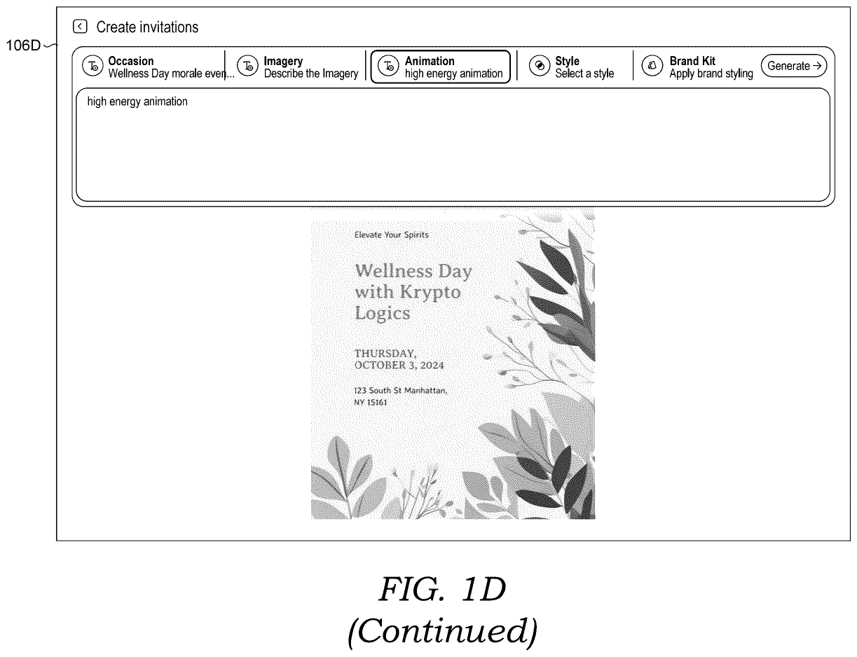

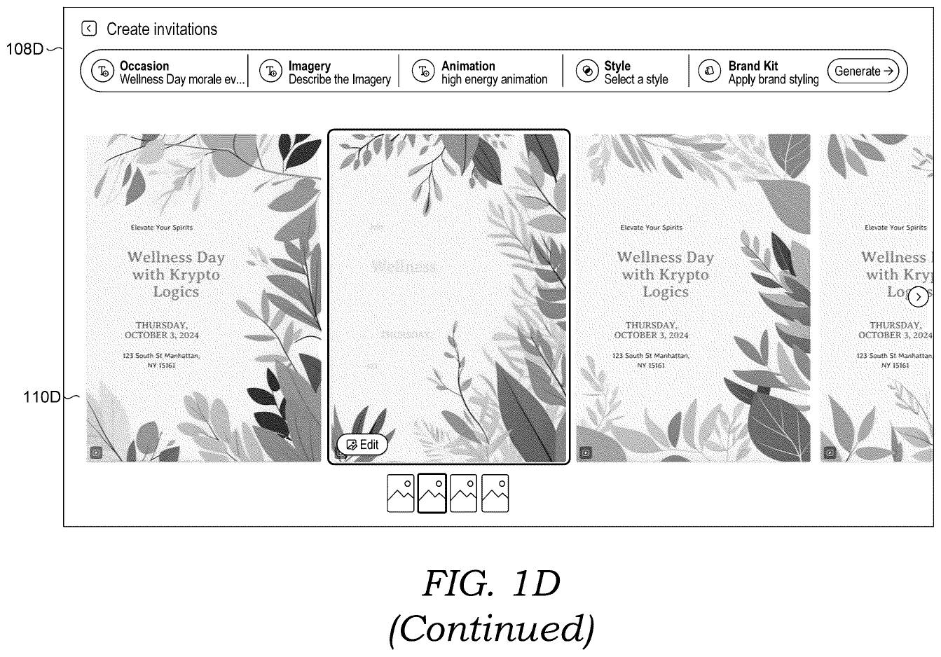

Aspects of the technical solution can be described by way of examples and with reference to FIGS. 1A-1D 2A and 2B. With reference to FIG. 1A, FIG. 1A illustrates a generative animation workflow flow for providing generative animation management using a generative animation engine. At a high level, the process is initiated by receiving an input, such as a user input 102A (e.g., “Wellness day for Krypto Logics”), which may be associated with a design template 104A. At block 106A (step 1), an emotional tone analysis is performed by the generative animation engine—such as a Large Language Model (LLM)—to match the contextual data of the input to an appropriate animation style; the LLM is employed to analyze the user query and determine a corresponding animation style (e.g., highly energetic).

In one embodiment, a meta-prompt is generated with using a multi-phase meta-prompt design that supports various functionalities of the generative animation engine. The meta-prompt can include instructions on how to analyze the user input 102A and detect the underlying emotional tone, context, and purpose of the content. In this way, a highly contextual analysis of the user's input is performed, from which the intended emotional tone, target audience, and event context are inferred. Key thematic and emotional cues are identified by the generative animation and categorized into a range of animation styles; for instance, terms such as “celebration,” “excitement,” or “joy” are mapped to a high-energy animation style, while phrases such as “relax,” “introspection,” or “calm” are aligned with a minimalist or soothing animation style.

Contextual hints, including those from professional events, personal celebrations, or social gatherings, are recognized by the generative animation engine, and the animation recommendations are subsequently fine-tuned so that the animation style is closely tailored not only to the intended mood but also to the nuances of the event or message type. The meta-prompt is also provided based on the input and a predefined meta-prompt template that defines the animation parameters as operational constraints for animation generation. The meta-prompt can include instructions to generation JSON animations based on an identified animation style.

At block 108A (step 2), using the meta-prompt, an animation object is generated by the generative animation engine, with the animation object comprises computed animation parameters tailored to the detected style from step 1. At block 110A (step 3), the meta-prompt is used to format and communicate the animation object, which is returned in a JSON format. This JSON output is applied to the design template 104A to generate animations 112A that are subsequently displayed on a design platform interface 114A.

With reference to the multi-phase meta-prompt design, the multi-phase meta-prompt design structures animation generation into sequential stages, ensuring precise, context-aware outputs. It begins with emotional tone analysis, where the LLM extracts emotional cues and contextual elements from the user's input, mapping it to an appropriate animation style such as celebratory, calming, or professional. In the guided animation generation phase, the system produces an animation object following predefined constraints, including timing values, transformations, and interpolation, structuring the output in JSON for consistency. Finally, the rendering optimization phase refines the animation for compatibility with rendering engines and design tools, enabling seamless integration into design platforms. This structured approach enhances accuracy, maintains stylistic coherence, and simplifies animation creation from text-based inputs.

By way of example, a user's query is analyzed by an LLM, and the right animation type is determined; for instance, a high-energy animation is identified as ideal for celebratory or playful content, such as a birthday invitation, while a calm, soothing animation is deemed better suited for introspective or relaxing content like a meditation event.

A meta-prompt is generated phases, in the emotional tone analysis phase, the meta-prompt is generated to instruct the LLM to carefully analyze the query and detect the underlying emotional tone, context, and purpose of the content, so that these elements can be matched with the most fitting animation style. Key themes and emotional cues are identified, and contextual hints are noted, so that style recommendations—whether high-energy, soothing, professional, or playful—can be made in accordance with the target audience and the intended purpose.

```
Meta-Prompt:
Your role in this phase is to carefully analyze the user's query and detect the underlying
emotional tone, context, and purpose of the content. Your goal is to match these elements
with the most fitting animation style to enhance the intended message or experience.
    Content Analysis:
    i. Identify key themes or emotional cues in the text, such as excitement, calmness,
    nostalgia, or urgency.
    ii. Look for contextual hints (e.g., celebratory events like birthdays, professional
    settings, casual social invites, introspective reflections) that could influence the tone
    and aesthetic of the animation.
    Tone Mapping to Animation Styles:
    iii. High-Energy Animation: Suitable for upbeat, dynamic, or celebratory content.
    This includes events that focus on excitement, joy, or urgency, such as party
    invites, sports events, or promotions. The animation might feature fast transitions,
    bold colors, and energetic movements to convey enthusiasm and action.
    iv. Soothing or Minimalist Animation: Ideal for calming or introspective content,
    like meditation sessions, wellness invitations, or reflective events. These animations
    would typically feature soft transitions, pastel or muted colors, and gentle
    movement to create a peaceful and serene experience.
    v. Professional and Sleek Animation: Appropriate for business-related content,
    such as corporate presentations, product launches, or formal invitations. The
    animation style here should be polished and sophisticated, using clean lines, smooth
    transitions, and a restrained color palette to convey professionalism.
    vi. Playful Animation: Best for fun, casual, or light-hearted content, such as
    children's parties or informal gatherings. The style would lean on whimsical
    designs, bright colors, and bouncy movements to communicate a sense of
    playfulness and light-heartedness.
    Customization for Audience and Purpose:
    vii. Consider the target audience (e.g., children, professionals, casual viewers) and
    adjust the animation style accordingly.
    viii. Assess whether the purpose is to inform, entertain, persuade, or relax, and
    ensure the animation style enhances this goal.
    Style Recommendations: After evaluating the content, suggest an
    (<<AnimationStyle>>) that aligns with the identified tone and purpose.
```

In the guided animation generation phase, the meta-prompt instructs animations to generated based on a set of guidelines that describe how to design both text animations and page animations, including specifications for timing values, interpolation curves, correct JSON code layout, and artistic input for staging animations. Adjustments for “mood” are incorporated by modifying timing, pixel distances traveled, transformation parameters, and interpolation curves to evoke a calm, medium, or high-energy feeling. A detailed meta-prompt is provided to the LLM so that even users without animation expertise can simply write a basic prompt to obtain the correct animation output. In this phase, the LLM is directed to generate four distinct JSON animations based on the extracted animation style, with each animation comprising two key components—a pageAnimation and a textAnimation—while adhering to the provided guidelines.

The animation object includes both pageAnimation and textAnimation components to allow for structured, hierarchical control over different elements within a design composition. This separation ensures that animations applied to the entire page (background, layout elements, or global transitions) remain distinct from animations affecting specific text elements, improving flexibility and modularity in animation design.

The pageAnimation component governs animations that apply to the entire design canvas, such as background transitions, page-wide motion effects, or large-scale transformations like zooming, panning, or fading in/out. These animations ensure smooth scene transitions and create a cohesive visual experience across the entire design.

The textAnimation component, on the other hand, specifically targets text elements within the design. This allows for finer control over typographic motion, including entry effects (e.g., fade-in, slide-in), emphasis animations (e.g., pulse, shake, bounce), and exit animations. By separating text-specific animations from page-level animations, the system ensures that text can be animated independently while maintaining synchronization with broader page transitions.

This division also improves processing efficiency, as each component can be optimized separately for rendering, ensuring that complex text animations do not interfere with global page transitions. Additionally, this structure aligns with multi-layered animation systems used in professional design tools, allowing for more dynamic and customizable motion effects across different visual elements in a design.

```
Meta-Prompt:
As a bot, your role in this phase is to generate four distinct JSON animations based on the
animation style you extracted in phase 1: (<<AnimationStyle>>). Each animation should
include two key components: a pageAnimation and a textAnimation. You will follow the
provided guidelines to ensure the animations meet the desired specifications.
  1. Introduce Variability: Each generated animation should incorporate unique parameter
    combinations such as translation, rotation, and scaling, alternating between page-only and
    page-and-text animations. The model varies animations each time, generating distinct
    JSON structures for unique outputs.
  2. Timing and Mood Control:
      a. The time values are adjusted to match the intended energy level, with specific
        ranges for “medium,” “high,” and “calm” energy animations.
      b. The fourth time value, which closes the animation, should be equal to the
        maximum time in any property for consistency and to avoid premature opacity
        changes.
Examples for Setting Timing by Energy Level:
      c. High Energy Animation: Begins at 0, with second time values from 1-2 seconds,
        and looping values up to 8 seconds.
      d. Medium Energy Animation: Begins at 0, with second time values from 1.5-2.5
        seconds, and looping values up to 10.5 seconds.
      e. Calm Energy Animation: Begins at 0, with second time values from 2-3 seconds,
        and looping values up to 12 seconds.
      f.
  3. Opacity and Hold Frame Adjustments:
      a. Opacity should start at 0 and animate to 1 within the first 1.5 seconds, scaling to
        the animation's energy level.
      b. Hold Frames are specified to ensure readability, with timings based on energy
        level:
          i. High Energy: 3.5-5 seconds
          ii. Medium Energy: 4-6 seconds
          iii. Calm Energy: 5-7 seconds
  4. Interpolation Curve Consistency:
      a. The meta-prompt restricts interpolation curves to specific types for smooth
        transitions, such as “EaseOut” at entry points.
      b. In looping animations, interpolation curves should appear on the first and third
        value lines, ensuring consistent entry and exit motions.
  5. Distribution Delay for Page and Text Animations:
      a. Distribution delays vary by energy level:
          i. High Energy: 0.05-0.2 seconds
          ii. Medium Energy: 0.1-0.3 seconds
          iii. Calm Energy: 0.2-0.4 seconds
  6. Looping Specifications and Formatting Rules:
      a. For looping, the second and third “value” lines in a keyframe should match,
        enabling smooth transitions. The final opacity time should match the longest
        duration in any keyframe, ensuring all animations fade simultaneously for loop
        continuity.
```

The zero-shot and multi-shot examples are provided in the guided animation generation phase of the multi-phase meta-prompt design. The LLM references predefined examples to ensure that animations align with contextual and technical constraints. Zero-shot examples are included in the meta-prompt to guide the LLM in generating animations even when it has not encountered a specific request before, allowing it to infer styles based on general knowledge. Multi-shot examples provide multiple variations of a given animation style, helping refine motion properties such as timing, interpolation, and transformations by demonstrating different ways to implement a specific animation effect. These examples ensure that the LLM generates diverse and high-quality animations, even when dealing with ambiguous or novel user inputs.

Finally, in the rendering optimization phase, the rendering of results is specified through a meta-prompt that instructs the LLM to structure the response as a dictionary containing four valid JSON objects, with no additional explanations or non-JSON content being included.

Meta-Prompt:
Output Format: Structure the response as a
dictionary containing 4 valid JSON objects,
with no explanations or non-JSON content.”

With reference to FIG. 1B, FIG. 1B illustrates the end-to-end process of generating and applying AI-driven animations within a design platform, utilizing a large language model (LLM), to generate structured animation objects. The generative animation engine workflow follows a multi-stage pipeline, with various components responsible for processing user input, generating animations, and applying them to design applications.

At a user input stage, the process begins within the design platform 102B, where a user selects a design template and inputs an animation prompt. The user animation prompt describes the intended design elements or animations. The selected design provides contextual information about the layout and elements available for animation.

At a preprocessing and routing stage, the user animation prompt and selected design are sent to the design platform service 104B for processing. design platform service 104B acts as a processing layer, forwarding the request to the appropriate backend system for animation generation. Once the animation object is generated, multiple animated design variations are created and sent back to the design platform 102B for user selection.

At an animation generation request stage, the design platform service 104B sends the user animation prompt and selected design to the LLM 108B. In one embodiment, design platform service 104B sends the user animation prompt and selected design via a presentation application suggestion service 106B. The presentation application suggestion service 106B prepares the animation prompt, which includes user animation prompts and meta-prompt (predefined animation rules, including timing constraints, transformation parameters, and energy-level adjustments).

The presentation application suggestion service 106B can be optionally provided as a standalone service that responsible for processing animation requests and generating context-aware animation recommendations for design applications. It acts as an intermediary between user inputs and the LLM 108B, ensuring that animations align with both design constraints and user intent.

Functionally, the presentation application suggestion service 106B receives a user animation prompt along with a selected design template, then constructs an animation prompt by incorporating a meta-prompt that defines animation rules, timing, and transformation constraints. This structured prompt is then sent to an LLM 108B which generates an animation object in JSON format. Once received, the animation object is applied to the design template, producing multiple animated variations that are returned to the user.

At an animation object generation stage, the LLM processes the request and generates an animation object in JSON format, encoding the computed animation parameters. The JSON object defines specific animation behaviors, such as: timing values (entry/exit durations); motion transformations (scaling, translation, rotation); opacity adjustments (fade-in, fade-out); looping and interpolation settings.

At a returning generated animations stage, the animation object in JSON format is sent back—optionally via the presentation application suggestion service 106B, that applies the generated animation to the selected design, ensuring proper synchronization with the layout and elements.

At a final animation integration stage, the design platform service 104B receives multiple animated designs created from the animation object. These variations allow users to select from different animation styles or effects. And at a user interaction and final selection stage, the animated designs are delivered back to the design platform 102B. The user is presented with multiple animation suggestions, allowing them to preview and select the most suitable animation for their design.

As such, the generative animation engine workflow supports automated animation generation, eliminating the need for manual keyframe animation. The generative animation engine provides a hierarchical processing pipeline, which is structured across multiple layers, starting from a design platform, moving through a design platform service, and culminating in an LLM. The meta-prompt ensures that animations are tailored to predefined rules, allowing for adjustments in energy levels, timing refinements, and interpolation control, all based on the specific context of the request.

The output from the LLM is machine-readable and structured in JSON format, ensuring smooth integration into design platforms. This approach provides several key benefits, such as scalability, where the LLM can handle multiple animation requests at once, allowing for batch generation. It also offers a user-friendly design experience, where users do not need animation expertise—by simply inputting natural language prompts, the generative animation engine generates animations automatically.

With reference to FIG. 1C, FIG. 1C illustrates a generative animation engine workflow for generating animated invitation designs using a generative animation engine. The generative animation engine workflow details how a user interacts with a design platform to create animated invitations based on natural language prompts, which are processed by a backend system and an LLM to generate structured animations. The flow is divided into user interaction, backend processing, animation generation, and final output delivery. FIG. 1D illustrates corresponding interface elements associated with the generative animation engine workflow.

The process begins when a navigates to a design platform interface (e.g., design platform interface 102D) and a plurality of templates are provided for a task (e.g., create an invitation 104D) and the user clicks on an invitation template 102C in the design platform. This template serves as the base design onto which animations will be applied.

The user provides inputs or writes a text-based prompt 104C associated with generating the invite (e.g., “high energy animation” in a prompt interface portion 106D). This allows for natural language-based animation generation, eliminating the need for manual animation configuration. The user's animation prompt and selected template 106C are forwarded to the backend system. This step ensures structured processing, where the design template and user-defined animation effects are analyzed.

The backend system generates multiple animation suggestions 108C based on the design and animation prompt. At this stage, two key parallel processes take place: multiple parallel requests are sent to an LLM 110C_1, where both the user prompt and a meta-prompt are included; and multiple invitation templates 110C_2 are created based on the selected design, ensuring diverse animation variations.

The animation objects generated LLM are structured in a machine-readable JSON format. These animation objects are applied to the invitation templates, ensuring that The animated invitation designs are compiled and delivered to the design application interface (e.g., design application interface 108D for animated invitation designs). Users are provided with multiple animated versions of their design (e.g., multiple animation versions 110D), allowing them to preview and select the best option. FIGS. 1C and 1D demonstrate how LLM-driven generative animation is seamlessly integrated into a design platform, enabling users to effortlessly create animated invitation designs while the system handles animation computation, styling, and rendering in the background.

With reference to the predefined meta-prompt template, the predefined meta-prompt template serves as a structured framework that defines animation parameters, constraints, and formatting rules, guiding the LLM in generating consistent and context-aware animations. It specifies timing, transformations, interpolation, energy levels, and example animations (zero-shot and multi-shot) to ensure alignment with user intent and rendering requirements. To generate this predefined meta-prompt template a systematic approach is followed, where animation categories are identified, operational constraints are established, timing and mood controls are defined, and structured formatting (e.g., JSON) is applied to ensure seamless integration into the animation generation pipeline.

Operationally, the process begins by categorizing animations into distinct types based on their emotional tone, content context, and intended purpose. These categories include high-energy animation, soothing or minimalist animation, professional and sleek animation, and playful animation. Each category reflects a different style and approach suited for various contexts or purposes.

Once the animation categories are established, the next step involves assigning attributes that define each category's style. For example, a high-energy animation might be characterized by fast transitions, bold colors, and energetic movements, while a soothing or minimalist animation could be defined by soft transitions, pastel colors, and gentle movement. These attributes ensure that the animation style aligns with the emotional tone or content's nature, such as excitement, calmness, or professionalism.

A structured framework of parameters that provide operational constraints for animation generation is generated. The parameters include content analysis, which involves identifying the emotional tone and contextual cues, and tone mapping, which aligns the identified tone with the appropriate animation style. Additionally, there is customization for the audience and purpose, where the animation is tailored to suit the specific audience and its intended purpose, whether to inform, entertain, persuade, or relax. Finally, style recommendations are provided based on the analysis and tone mapping, suggesting the most fitting animation style.

With the framework defined, the final step is to generate a predefined template that serves as a guide for creating animations based on the user's query. This template outlines how to analyze the content, match it with the correct animation style, and provide recommendations that align with the purpose and audience. The meta-prompt includes clear instructions for analyzing the content's emotional tone and context, mapping it to the relevant animation styles, and ensuring that the final recommendation serves the intended experience. This structured process ensures that each animation is purposefully crafted, with operational constraints that enable generating an animation style that effectively communicates the intended message.

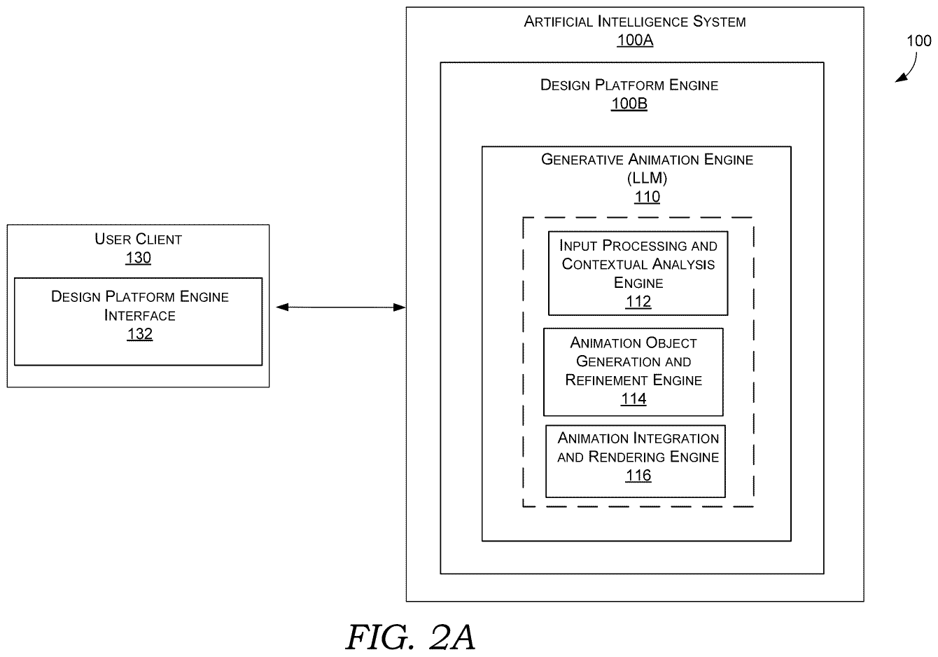

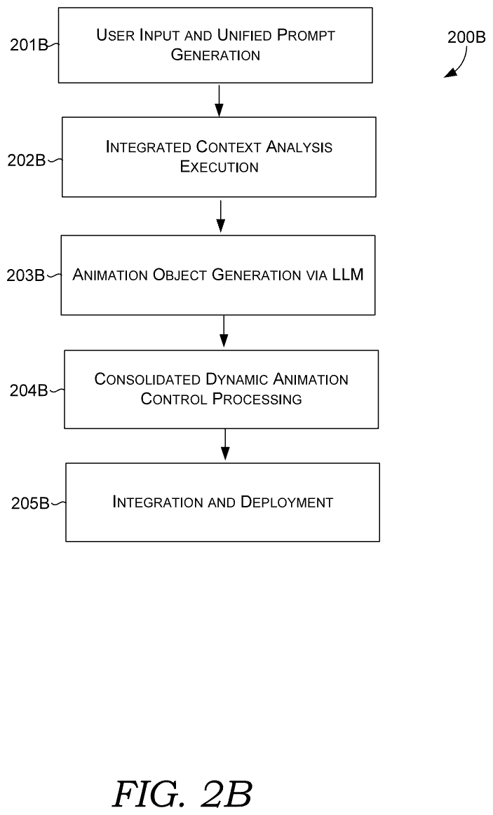

With reference to FIG. 2A, FIG. 2A, illustrates a cloud computing system 100, artificial intelligence (AI) system 100A, design platform engine, generative animation engine 110, prompt engine 112, integrated content analysis engine 114, and consolidated dynamic animation control engine 116, user client 130, and design platform engine interface 142.

The cloud computing system 100 provides the foundational infrastructure for processing, storing, and managing animation generation requests. Cloud computing system 100 enables distributed computing, ensuring that the generative animation workflow can scale efficiently by leveraging cloud-based resources to handle multiple user requests simultaneously. The AI system 100A serves as the core intelligence layer responsible for processing user animation prompts, contextual cues, and predefined animation rules. It incorporates machine learning models, including large language models (LLMs), to interpret user intent, generate structured animation outputs, and optimize motion properties based on detected themes.

The design platform engine 100B manages the integration of animations within a design environment, ensuring that generated animations align with template constraints, layout considerations, and rendering capabilities. Design platform engine 100B acts as a middleware layer that translates structured animation objects (e.g., JSON-based motion data) into visually coherent animations applied to text, shapes, and background elements. Design platform engine 100B provides as the core design application environment where users create and modify visual content. It provides a canvas for composition, manages template-based designs, and integrates AI-driven animation generation into the user workflow.

Design platform engine 100B interacts with the generative animation engine 110 and the design platform engine interface 132 (GUI) to allow users to apply LLM-generated animations to text, shapes, and other design elements. It ensures that the animations align with layout constraints, rendering capabilities, and stylistic consistency within the platform, making it a fully integrated AI-assisted design tool.

The generative animation engine 110 operates as an LLM that is responsible for creating, structuring, and refining animation objects based on user input and meta-prompts. It processes animation requests, applies motion constraints, and generates computed animation parameters, ensuring that animations are contextually relevant, smooth, and visually appealing.

The input processing and contextual analysis engine 112 is responsible for extracting, structuring, and interpreting user input to generate a meta-prompt that accurately defines the parameters for animation generation. The input processing and contextual analysis engine 112 processes user-provided text-based prompts and selected template designs, applying natural language processing (NLP) to analyze contextual cues, emotional tone, and thematic elements. Emotional tone analysis is executed to classify the animation intent into predefined animation styles, ensuring alignment with the user's contextual needs. The input processing and contextual analysis engine 112 then constructs a structured meta-prompt by incorporating predefined operational constraints, including transformation rules, interpolation methods, timing distributions, and animation energy levels. This meta-prompt provides a standardized instruction set for animation object generation, ensuring that all outputs adhere to predefined stylistic and technical parameters.

The animation object generation and refinement engine 114 receives the structured meta-prompt and executes the transformation of animation intent into a structured animation object. The animation object generation and refinement engine 114 synthesizes computed animation parameters, including timing sequences, keyframe placement, transformation effects, opacity transitions, and motion interpolation properties. The animation object is generated in a standardized format, such as JSON, encoding hierarchical relationships between page-level and text-level animations. A refinement operation is applied to optimize animation sequencing, ensuring smooth motion transitions, proper timing synchronization, and logical distribution of animated elements. Additionally, optimization constraints are enforced to maintain visual consistency across varying animation styles, ensuring that transitions, delays, and motion profiles adhere to the predefined animation categories.

The animation integration and rendering engine 116 is responsible for processing the structured animation object and applying it to the selected template within the design platform. The animation integration and rendering engine 116 formats the animation object into a machine-readable dictionary structure, ensuring compatibility with the rendering pipeline. The integration process aligns the generated animation with the spatial constraints and layout structure of the selected design template, maintaining hierarchical relationships between animated components. Rendering optimizations are applied to ensure motion coherence, frame rate consistency, and animation fluidity. The finalized animation is then deployed within the design platform interface, where users can preview, modify, and finalize the animated content. The animation integration and rendering engine 116 ensures that AI-generated animations are seamlessly integrated, dynamically responsive, and visually aligned with the intended animation behavior, eliminating the need for manual keyframe adjustments while maintaining high fidelity and precision in motion execution.

The user client 130 acts as the interface between the system and the end-user, facilitating interaction with the animation generation process. It functions as a graphical or text-based user interface where users can input animation requests, preview generated animations, and make adjustments based on the system's outputs. The user client 130 receives raw input from users and forwards it to the prompt engine 112, initiating the backend processing pipeline. Once animation objects have been generated and refined, the user client 130 renders previews and allows users to integrate animations into their designs within the selected platform. Inputs to the user client 130 include text-based user requests, animation settings, and preview adjustments. Outputs include system-generated animation previews, applied design elements, and finalized animation sequences that can be exported or embedded into a project.

The user client 130 serves as the interface through which users interact with the system, allowing them to input animation requests, select templates, preview generated animations, and make adjustments. It provides a user-friendly experience by abstracting technical complexities and enabling text-based animation control without requiring manual keyframe adjustments. Design platform engine interface 132 functions as a GUI that allows users to interact with the design platform visually. It provides tools for inputting animation prompts, selecting templates, previewing animations, and making adjustments to the generated animations.

For clarity and efficient reference, a glossary of key terms and concepts pertinent to the technical solution is provided below.

Generative Animation—A dynamically created animation generated by an AI system based on user input and predefined constraints without requiring manual keyframe adjustments.

Generative Animation Engine—A system that processes user input, applies structured animation rules, and generates AI-driven animations using a large language model (LLM).

Meta-Prompt Generation—The process of creating a structured prompt that includes contextual information, animation parameters, and predefined constraints to guide the LLM in generating animations.

Predefined Meta-Prompt Template—A structured framework containing animation rules, constraints, and reference examples used to standardize meta-prompt generation for consistent animation outputs.

Multi-Phase Meta-Prompt Design—A structured prompt-processing approach consisting of sequential stages such as emotional tone analysis, guided animation generation, and rendering optimization.

Animation Object—A structured digital representation of an animation, encoded with computed parameters such as timing, transformations, and interpolation curves.

Computed Animation Parameters—The set of dynamically generated values that define animation behavior, including timing, transformation properties, motion interpolation, and looping controls.

User Prompt—A natural language input provided by a user describing the desired animation effect, which serves as the basis for AI-driven animation generation.

Contextual Data for Animation Generation—Information extracted from the user prompt, including tone, event type, and design context, used to match the animation style to the intended purpose.

Selected Template Design—A predefined design layout chosen by the user that serves as the base structure onto which the generated animation is applied.

Operational Constraints for Animation Generation—The predefined parameters that regulate animation behavior, such as speed limits, transformation rules, timing sequences, and allowed motion styles.

Page Animation Portion—The segment of the animation object that applies motion effects to the entire design canvas, including background transitions and layout animations.

Text Animation Portion—The segment of the animation object that applies motion effects specifically to text elements, including entrance, emphasis, and exit animations.

Standard Dictionary Format for Animation Object—A structured format, typically JSON, used to encode animation objects in a machine-readable manner for seamless integration into design platforms.

Determining Animation Categories—The classification of animations into predefined categories, such as high-energy, minimalistic, or professional, based on contextual and thematic cues.

Animation Category Attributes—The specific properties assigned to an animation category, including timing profiles, transformation rules, and stylistic characteristics.

Assigning Attribute Values to Animation Categories—The process of mapping numerical or descriptive values (e.g., speed, duration, transition type) to predefined animation categories.

Defining Structured Animation Framework—The establishment of a standardized system for generating and refining animations, ensuring consistency across various animation requests.

Generating Predefined Meta-Prompt Template—The creation of a reusable structured template that defines animation constraints, reference styles, and example outputs for guiding AI-driven animation generation.

Applying Predefined Optimization Rules—The process of refining animations by enforcing predefined motion principles, such as smooth transitions, proper timing distribution, and visual consistency.

Automated Generative Animation Pipeline—A fully AI-driven workflow that processes user input, generates animations using an LLM, applies refinements, and integrates animations into design platforms.

Causing Display of Generative Animation—The final step in the process where the generated animation is rendered and displayed within the user interface of the design platform.

With reference to FIG. 2B, FIG. 2B a flow chart 200B associated with providing a generative animation management using a generative animation engine in accordance with embodiments described herein. The technical solution of the generative animation engine can be explained by way of steps and an example scenario.

At step 201B—User Input and Unified Prompt Generation: The process begins with the acquisition of user input, which is merged with a predefined meta-prompt template to form a unified directive—a meta-prompt. The meta-prompt encapsulates both the creative intent of the user and the technical specifications—such as animation behavior, timing, and transformation details—that will guide the LLM.

At step 202B—Integrated Content Analysis Execution: The meta-prompt is then processed by the generative animation engine. The generative animation engine examines the input for emotional cues, contextual hints, and thematic elements. This step involves mapping detected emotions (e.g., excitement, calm) to corresponding animation styles and setting initial parameters based on the user's context.

At step 203B—Animation Object Generation via LLM: Using the insights gained from the content analysis, the generative animation engine generates a structured animation object, typically formatted in JSON. This output details specific animation parameters, including timing sequences, interpolation curves, and transformation instructions, and can be divided into distinct components such as pageAnimation and textAnimation.

At step 204B—Consolidated Dynamic Animation Control Processing: The generated animation object is then refined by the generative animation engine. In this phase, the generative animation engine adjusts timing values, opacity transitions, hold frames, and looping specifications to ensure smooth, consistent animations that adhere to the defined energy levels (high, medium, calm). This step ensures that the dynamic aspects of the animation are optimized for seamless integration.

At step 205B—Integration and Deployment: Finally, the refined animation object is integrated into the target design platform. The generative animation engine deploys the animation into the design environment, allowing for a final verification and preview to confirm that the animation behaves as intended within the overall design context.

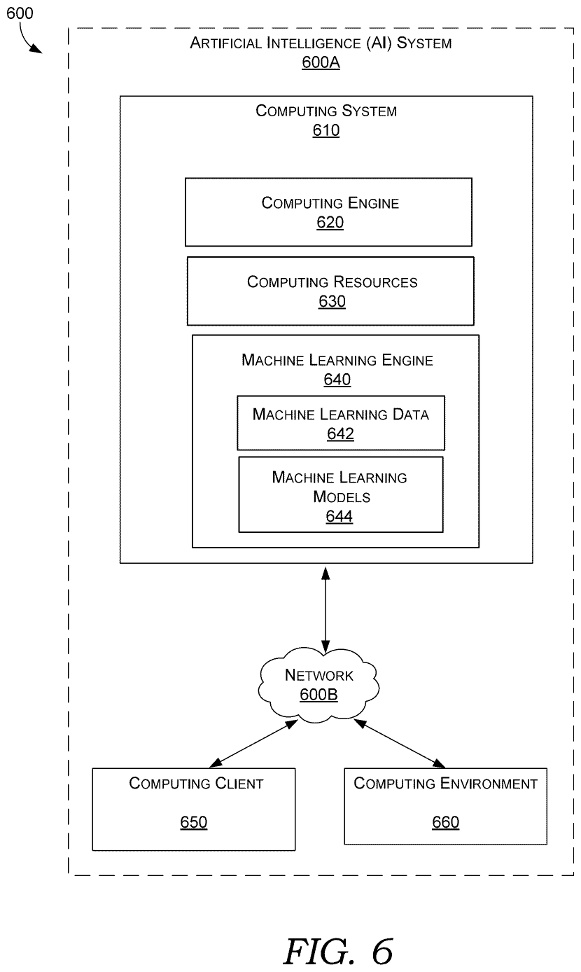

Aspects of the technical solution have been described by way of examples and with reference to FIGS. 1A-1D, 2A and 2B. FIG. 2A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 2A illustrates a high-level architecture of the cloud computing system 100 in accordance with implementations of the present disclosure, among other engines, managers, generators, selectors, or components not shown (collectively referred to herein as “components”).

### Example Methods

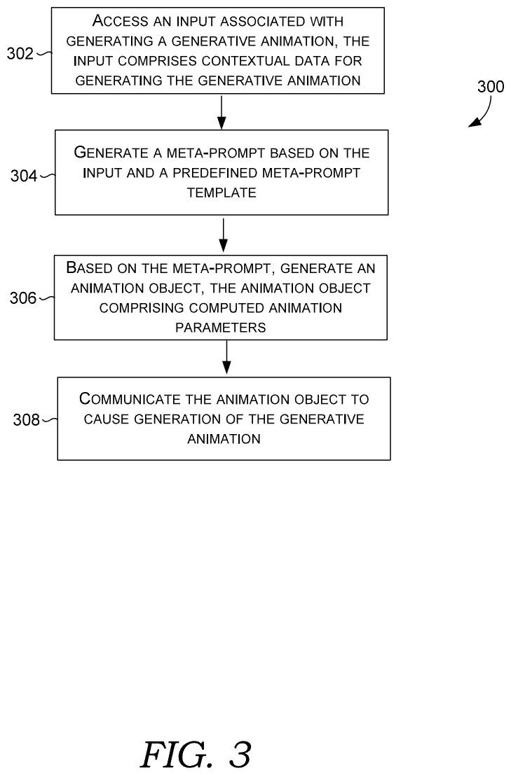

With reference to FIGS. 3, 4, and 5, flow diagrams are provided illustrating methods for providing generative animation management using a generative animation engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in the artificial intelligence system (e.g., a computerized system).

Turning to FIG. 3, a flow diagram is provided that illustrates a method 300 for providing generative animation management using a generative animation engine in an artificial intelligence system. At block 302, access an input associated with generating a generative animation, wherein the input comprises contextual data for generating the generative animation. At block 304, generate a meta-prompt based on the input and a predefined meta-prompt template, wherein the predefined meta-prompt template defines animation parameters as operational constraints for animation generation. At block 306, based on the meta-prompt, generate an animation object, wherein the animation object comprises computed animation parameters. At block 308, communicate the animation object to cause generation of the generative animation.

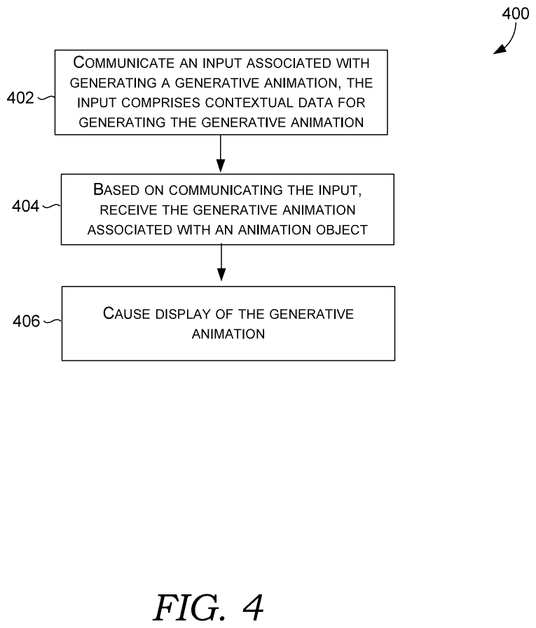

Turning to FIG. 4, a flow diagram is provided that illustrates a method 400 for providing generative animation management using a generative animation engine in an artificial intelligence system. At block 402, communicate an input associated with generating a generative animation, the input comprises contextual data for generating the generative animation. At block 404, based on communicating the input, receive the generative animation associated with an animation object, the animation object is generated based on a meta-prompt associated with the input and a predefined meta-prompt template, wherein the predefined meta-prompt template defines animation parameters as operational constraints for animation generation. At block 406, cause display of the generative animation.

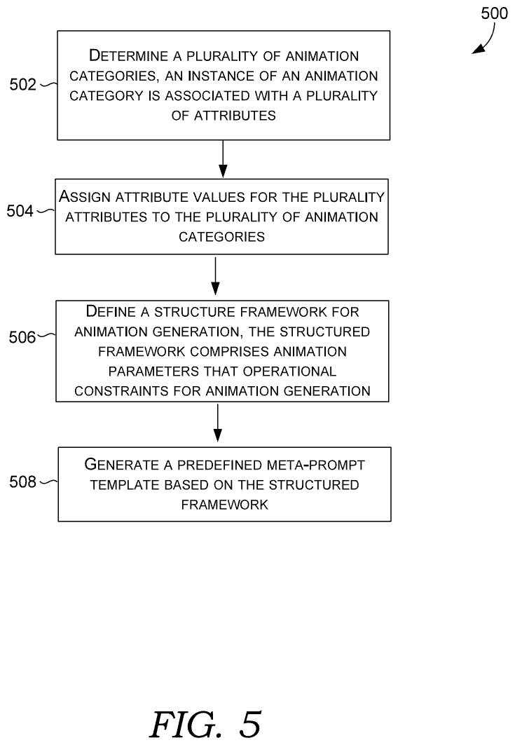

Turning to FIG. 5, a flow diagram is provided that illustrates a method 500 for providing generative animation management using a generative animation engine in an artificial intelligence system. At block 502, determine a plurality of animation categories, an instance of an animation category is associated with a plurality of attributes. At block 504, assign attribute values for the plurality of attributes to the plurality of animation categories. At block 506, define a structured framework for animation generation, the structured framework comprises animation parameters that are operational constraints for animation generation. At block 508, generate a predefined meta-prompt template based on the structured framework.

### Technical Improvement

Embodiments of the present techniques have been described with reference to several inventive features (e.g., operations, systems, engines, and components) associated with an artificial intelligence system. Inventive features described include operations, interfaces, data structures, and arrangements of computing resources associated with providing the functionality described herein relative with reference to a generative animation engine. Functionality of the embodiments of the present invention have further been described, by way of an implementation and anecdotal examples—to demonstrate that the operations for providing the generative animation engine as a solution to a specific problem in artificial systems technology to improve computing operations in artificial intelligence systems.

The generative animation engine functions based on operations that form a structured pipeline for generating and applying animated design objects. The generative animation engine receives an input consisting of a user-provided text prompt, which is combined with predefined animation rules and structured formatting constraints to form a unified prompt. This prompt ensures that the request includes both creative intent and technical animation parameters. Next, a content analysis operation is performed, where an AI model processes the unified prompt to extract contextual meaning, emotional tone, and animation requirements. This step enables the generative animation engine to align animation behaviors with the inferred thematic and expressive characteristics of the design request.

Once the analysis is complete, the generative animation engine executes a generative operation where the AI model synthesizes an animation object in a structured format, such as JSON, encoding specific animation properties including timing, transformations, interpolation curves, and looping behaviors. A refinement operation follows, where the generative animation engine applies predefined optimization rules to ensure smooth motion transitions, appropriate timing distributions, and cohesive visual interactions among multiple animated elements. Finally, the animation object is integrated into a design platform, allowing seamless application to text, shapes, or other graphical elements within a user's composition.

The generative animation engine represents a significant technical improvement by introducing an adaptive, context-driven animation generation process that eliminates the need for predefined animation templates or manually configured keyframes. Unlike traditional systems that rely on static animation libraries or extensive manual input, this approach dynamically generates animations tailored to the specific intent and contextual cues extracted from user input, enabling highly personalized and thematically consistent animations.

The generative animation engine employs a structured data-driven representation for animations, allowing automated synthesis of animation behaviors while ensuring compatibility with downstream rendering engines. By encoding animations in a structured format such as JSON with explicit timing and transformation properties, the approach facilitates seamless integration into various design tools without requiring manual conversion or frame-by-frame adjustments.

The generative animation engine optimizes animation sequences using a structured meta-prompt and predefined animation constraints, ensuring that generated animations maintain smooth transitions, balanced timing distributions, and energy-matched motion behaviors. This contrasts with conventional approaches where achieving polished animations typically requires iterative manual refinements, making the disclosed method significantly more efficient in terms of automation, usability, and design consistency.

### ADDITIONAL SUPPORT FOR DETAILED DESCRIPTION

### Example Artificial Intelligence (AI) System in a Computing Environment

Referring now to FIG. 6, FIG. 6 illustrates a computing environment in which implementations of the present disclosure may be employed. In particular, FIG. 6 shows a high level architecture of an example cloud computing platform 600, artificial intelligence (AI) system 600A, and computing system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services—including compute, servers, storage, databases, networking, and intelligence. The components of cloud computing platform 600 may communicate with each other over a network 600B which may include, without limitation, one or more local area networks (LANs) and/or wide area networks (WANs).

The AI system 600A provides a specialized infrastructure designed to support the computational demands of artificial intelligence (AI) workloads, including both training and inference tasks. The AI backend network systems 600A consists of interconnected components that facilitate the efficient processing, communication, and management of data within a distributed computing environment. Operations include data processing, handling input data, intermediate results, and output data, alongside complex computations for AI tasks, communication facilitating seamless interaction among components, and resource management overseeing optimal utilization of compute nodes, accelerators (e.g., GPUs, TPUs), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 600 provides the foundational infrastructure and resources for deploying and managing computing workloads, including AI. AI system 600A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 610 provides computing functionality for computing environments. For example, the computing system 610 is a platform or framework that leverages advanced technologies such as artificial intelligence (AI), machine learning (ML), data mining, and big data analytics to extract actionable insights and knowledge from large and complex datasets. In this way, the computing system 610 provides a computing environment that enables organizations to make informed decisions and optimize operations.

The computing system 610 includes a computing engine 620 that is a computing environment that supports executing computational tasks associated with the computing system 610. The computing engine 620 can be a hardware or software component that performs computational operations, such as, mathematical calculations, data processing, and algorithm execution. The computing system 610 integrates computing resources 630 into computing system 610 to effectively provide computing functionality in a computing environment.

The computing resources 630 refer to computing elements (e.g., components, capability, or entities) that collectively enable the computing engine 620 operations. The computing resources 630 encompass a spectrum of computing elements, beginning with the diverse operations the computing resources 630 can perform, ranging from complex computations to data manipulations. Interfaces, an integral part of the computing resources 630, provide the means for both user interaction and seamless integration with external systems, ensuring a dynamic and interactive computing experience. The data facet of the data computing resources 630 involves various types: input data, which is the information provided for processing; processing data, representing the data manipulated during computational tasks; and output data, the results generated by the computing engine 620. In this way, the computing resources 630 support the broader computing engine 620 and computing system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 640 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The computing client 650 supports access to computing system 610. The computing client 650 can be provided as a user client or an administrator client to support user and administrator functionality associated with the computing environment 660, computing engine 620, or computing system 610. The computing client 650 can also support accessing computing visualizations and causing display of the computing visualization. The computing client 650 can include a computing engine client that supports receiving computing information associated computing engine 620 output from the computing system 610 and causing presentation of the computing information. The computing information can specifically include computing visualizations associated with the computing engine 620 output.

Computing environment 660 is a computing environment that is integrated into the computing system 610. The computing environment 660 is characterized by an infrastructure, where data from various sources within the ecosystem, including servers, networks, applications, sensors, and user interactions, can be aggregated and processed by the computing system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

### Example Distributed Computing System Environment

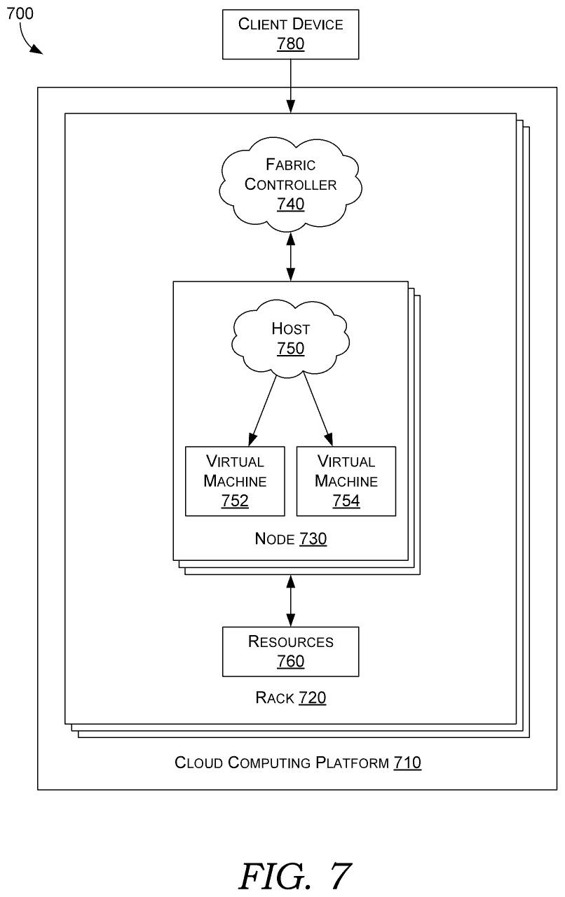

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

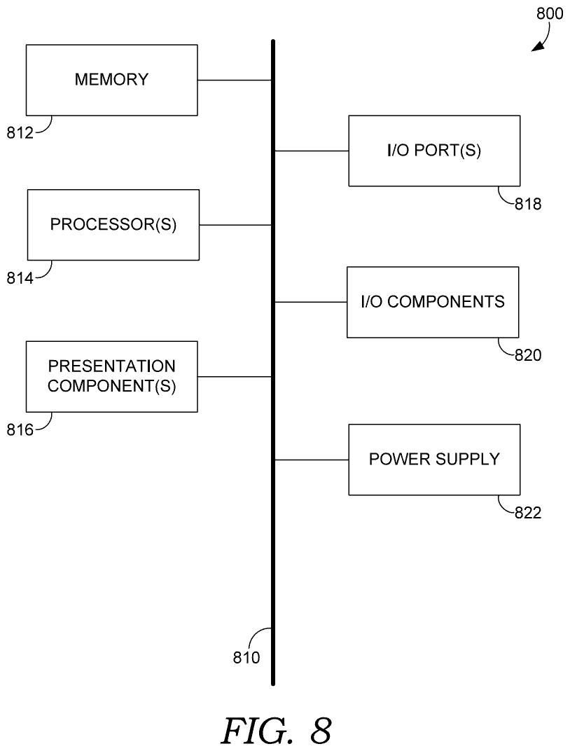

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors;
computer memory storing computer-useable instructions that, when used by the one or more computer processors, cause the one or more computer processors to perform operations, the operations comprising:
accessing an input associated with generating a generative animation, wherein the input comprises contextual data for generating the generative animation;
generating a meta-prompt based on the input and a predefined meta-prompt template, wherein the predefined meta-prompt template defines animation parameters as operational constraints for animation generation;
based on the meta-prompt, generating an animation object, wherein the animation object comprises computed animation parameters; and
communicating the animation object to cause generation of the generative animation.

2. The system of claim 1, wherein the input is a user prompt associated with a selected template design received via a design platform interface of a design platform, wherein the design platform is integrated with a generative animation engine that supports automated generative animation using a Large Language Model (LLM).

3. The system of claim 1, wherein the animation parameters comprise one or more of: a behavioral property, a timing sequence, a motion interpolation, or a speed control.

4. The system of claim 1, wherein the meta-prompt is associated with zero-shotting and multi-shotting to establish reference outputs for a Large Language Model to generate the generative animation.

5. The system of claim 1, wherein generating the meta-prompt is based on executing an emotional tone analysis on the input, wherein the emotional tone analysis enables matching the contextual data of the input to an animation style for the generative animation.

6. The system of claim 1, wherein generating the animation object comprises encoding one or more animation properties comprising timing, transformation, interpolation curves, and looping behaviors.

7. The system of claim 1, wherein the animation object comprises a page animation portion and a text animation portion that support a structured and hierarchical control over elements in the animation object.

8. The system of claim 1, wherein generating the animation object is further based on a refinement operation that applies predefined optimization rules associated with one or more of: smooth motion transitions, timing distributions, and visual interactions between multiple animated elements.

9. The system of claim 1, wherein communicating the animation object to causes generation of the generative animation is based the meta-prompt that supports delivering the generative animation in a standard dictionary format.

10. The system of claim 1, wherein generating the meta-prompt is based on a multi-phase meta-prompt design comprising an emotional tone analysis phase, a guided animation generation phase, and a rendering optimization phase.

11. One or more computer-storage media having computer-executable instructions embodied thereon that, when executed by a computing system having a processor and memory, cause the processor to perform operations, the operations comprising:
communicating an input associated with generating a generative animation, wherein the input comprises contextual data for generating the generative animation;
based on communicating the input, receiving the generative animation associated with an animation object, the animation object is generated based on a meta-prompt associated with the input and a predefined meta-prompt template, wherein the predefined meta-prompt template defines animation parameters as operational constraints for animation generation; and
causing display of the generative animation.

12. The media of claim 11, wherein the input is a user prompt associated with a selected template design received via a design platform interface of a design platform, wherein the design platform is integrated with a generative animation engine that supports automated generative animation using a Large Language Model (LLM).

13. The media of claim 11, wherein the predefined meta-prompt template is associated with zero-shotting and multi-shotting to establish reference outputs for a Large Language Model to generate the generative animation.

14. The media of claim 11, wherein the animation object comprises a page animation portion and a text animation portion that support a structured and hierarchical control over elements in the animation object.

15. The media of claim 11, wherein the generative animation is generated based on integrating the animation object into a selected template associated with the input for generating the generative animation.

16. A computer-implemented method, the method comprising:
determining a plurality of animation categories, wherein an instance of an animation category is associated with a plurality of attributes;
assigning attribute values for the plurality attributes to the plurality of animation categories;
defining a structured framework for animation generation, wherein the structured framework comprises animation parameters that are operational constraints for animation generation; and
generating a predefined meta-prompt template based on the structured framework, wherein the predefined meta-prompt template supports automatic generation of animation objects.

17. The method of claim 16, wherein the predefined meta-prompt template is associated with zero-shotting and multi-shotting to establish reference outputs for a Large Language Model to generate the generative animation.

18. The method of claim 16, wherein the predefine meta-prompt template is associated with a refinement operation that applies predefined optimization rules associated with one or more of: smooth motion transitions, timing distributions, and visual interactions between multiple animated elements.

19. The method of claim 16, wherein the predefined meta-prompt template is associated with generating an animation object comprising page animation portion and a text animation portion that support a structured and hierarchical control over elements in the animation object.

20. The method of claim 16, wherein generating a meta-prompt from the predefined meta-prompt template is based on a multi-phase meta-prompt design comprising an emotional tone analysis phase, a guided animation generation phase, and a rendering optimization phase.
